(19) United States
(12) Patent Application Publication
(10) Pub. No.: US 2026/0341599 A1
(43) Pub. Date: Oct. 29, 2026

(54) MULTILAYER CERAMIC CAPACITOR

(71) Applicant: Murata Manufacturing Co., Ltd., Nagaokakyo-shi (JP)

(72) Inventors: Yuta KUROSU, Nagaokakyo-shi (JP); Yuta SAITO, Nagaokakyo-shi (JP); Daiki FUKUNAGA, Nagaokakyo-shi (JP); Masahiro WAKASHIMA, Nagaokakyo-shi (JP)

(21) Appl. No.: 19/712,595

(22) Filed: Jun. 18, 2026

Related U.S. Application Data
(63) Continuation of application No. PCT/JP2024/033867, filed on Sep. 24, 2024.

(30) Foreign Application Priority Data
Dec. 21, 2023 (JP) 2023-216116

(51) Int. Cl. H01G 4/224; H01G 4/12; H01G 4/232; H01G 4/30

(52) U.S. Cl. CPC H01G 4/224; H01G 4/232; H01G 4/30; H01G 4/12

(57) ABSTRACT

A multilayer ceramic capacitor includes a multilayer body including an inner layer portion in which an inner electrode layer and a dielectric layer are stacked, and a side-margin portion on each of two sides of the inner layer portion in a width direction, and an outer electrode on each of end surfaces on two sides of the multilayer body in a length direction. In the multilayer body, a first glass layer is located on each of the two sides of the inner layer portion in the width direction along at least one of the end surfaces.

### CROSS REFERENCE TO RELATED APPLICATIONS

This application claims the benefit of priority to Japanese Patent Application No. 2023-216116 filed on Dec. 21, 2023 and is a Continuation Application of PCT Application No. PCT/JP2024/033867 filed on Sep. 24, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

To date, multilayer ceramic capacitors have been widely used in various electronic devices such as mobile terminals, like mobile phones, and personal computers. Due to recent development of electronic devices, further miniaturization, increase in capacitance, and high moisture resistance are required for multilayer ceramic capacitors.

In general, a multilayer ceramic capacitor has a structure including a multilayer body including an inner layer portion in which dielectric layers and inner electrode layers are alternately stacked and an outer layer portion formed by stacking dielectric layers on each of an upper part and a lower portion of the inner layer portion, and an outer electrode on each of two end surfaces of the multilayer body in the longitudinal direction. In order to improve moisture resistance, for example, a technique of mixing SiO₂ in the dielectric layers of the inner layer portion and the dielectric layers of the outer layer portion with different concentrations is known (Japanese Unexamined Patent Application Publication No. 2015-216337).

### SUMMARY OF THE INVENTION

However, the moisture resistance of a multilayer ceramic capacitor may decrease when water enters through a gap between the multilayer body and the outer electrode and reaches the inner electrode layer exposed on an end surface of the multilayer body. Therefore, it is difficult to produce a sufficient effect by only mixing SiO₂ in the dielectric layers of the inner layer portion and in the dielectric layers of the outer layer portion with different concentrations.

Example embodiments of the present invention prevent ingress of water through a gap between a multilayer body and an outer electrode and provide multilayer ceramic capacitors with high moisture resistance.

The inventors have conceived of and developed example embodiments of the present invention by discovering that it is possible to prevent ingress of water through a gap between a multilayer body of and an outer electrode of a multilayer ceramic capacitor and to obtain high moisture resistance by providing a glass layer extending in a stacking direction along an end surface of the multilayer body on each of two sides of an inner layer portion of the multilayer body in a width direction.

A multilayer ceramic capacitor according to an example embodiment of the present invention includes a multilayer body including an inner layer portion including an inner electrode layer and a dielectric layer stacked on each other, and a side-margin portion on each of two sides of the inner layer portion in a width direction intersecting a stacking direction, and an outer electrode on each of end surfaces on two sides of the multilayer body in a length direction intersecting the stacking direction and the width direction. In the multilayer body, a first glass layer is located on each of the two sides of the inner layer portion in the width direction along at least one of the end surfaces.

With each of the example embodiments of the present invention, it is possible to prevent ingress of water through a gap between a multilayer body and an outer electrode and provide a multilayer ceramic capacitor having high moisture resistance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor according to the present example embodiment of the present invention.

FIG. 2 is a cross-sectional view taken along line II-II (LT cross section) of the multilayer ceramic capacitor illustrated in FIG. 1.

FIG. 3 is a cross-sectional view taken along line III-III (LW cross section) of the multilayer ceramic capacitor illustrated in FIG. 2.

FIG. 4 is a cross-sectional view taken along line IV-IV (WT cross section) of the multilayer ceramic capacitor illustrated in FIG. 3.

FIG. 5 is a cross-sectional view taken along line V-V (WT cross section) of the multilayer ceramic capacitor illustrated in FIG. 3.

FIGS. 6A and 6B illustrate two inner electrode patterns on a dielectric sheet.

FIG. 7 illustrates a step of forming the multilayer ceramic capacitor illustrated in FIG. 1.

FIG. 8 illustrates a step of forming the multilayer ceramic capacitor illustrated in FIG. 1.

### DETAILED DESCRIPTION OF THE EXAMPLE EMBODIMENTS

Hereafter, multilayer ceramic capacitors according to example embodiments of the present invention will be described. However, the present invention is not limited to these example embodiments. Figures may be illustrated schematically in a simplified form in order to illustrate the contents of the invention, and illustrated elements or the ratios between the dimensions of elements might not coincide with the ratios between the dimensions of 41 elements described in the specification. Elements described in the specification may be omitted in the figures, or the number of the elements may be reduced in the figures.

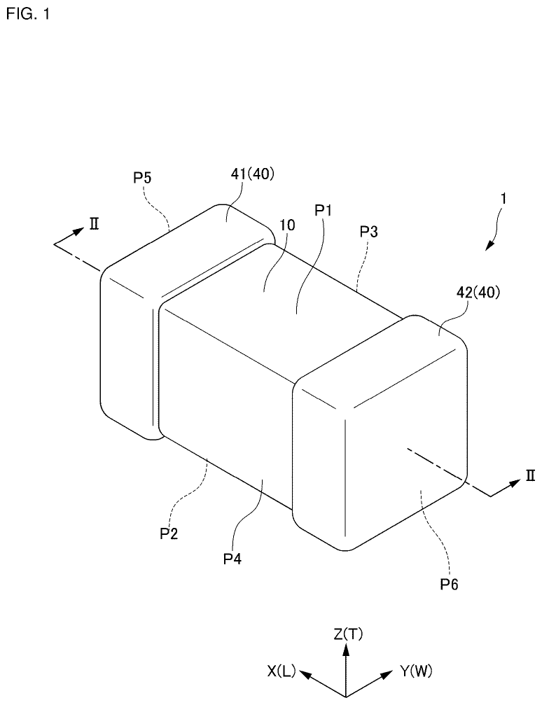

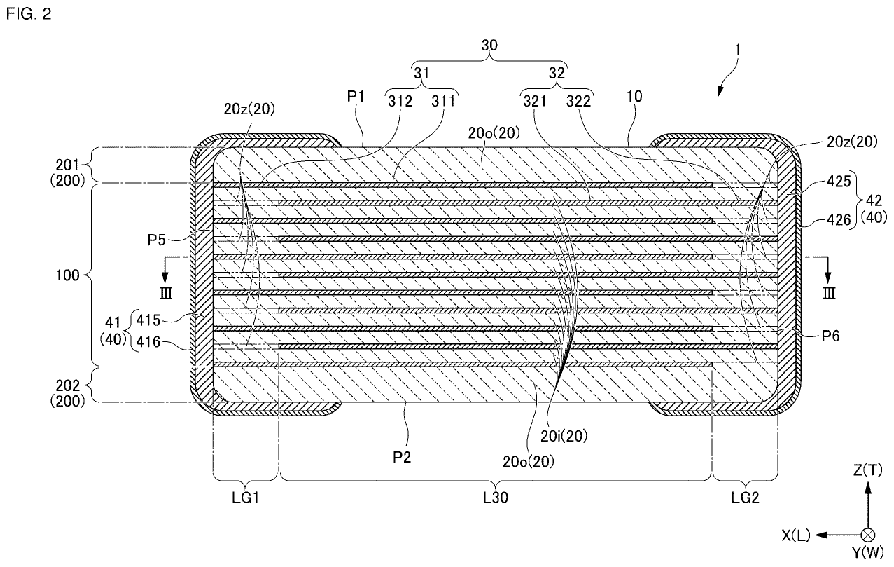

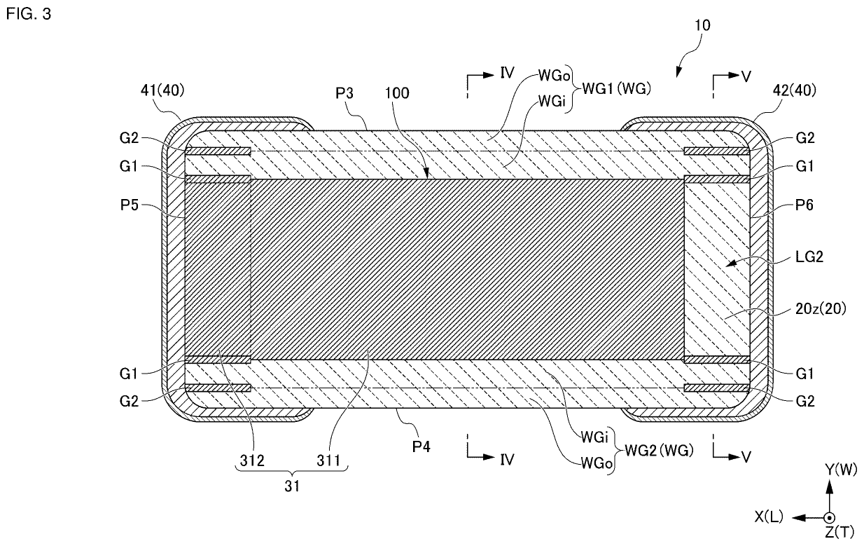

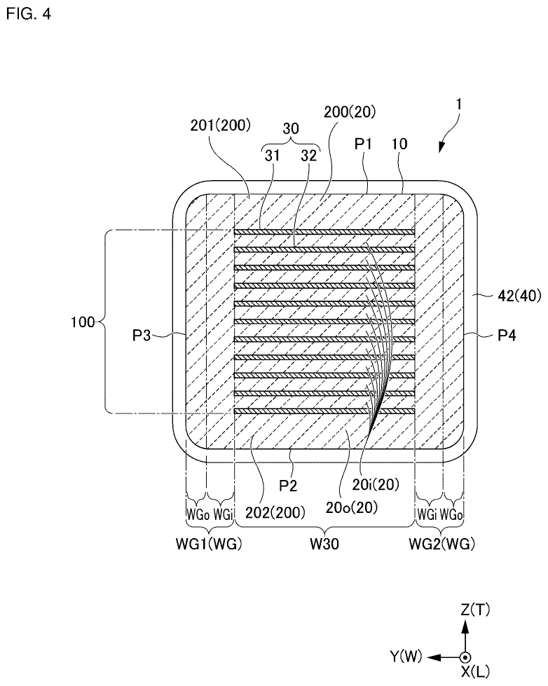

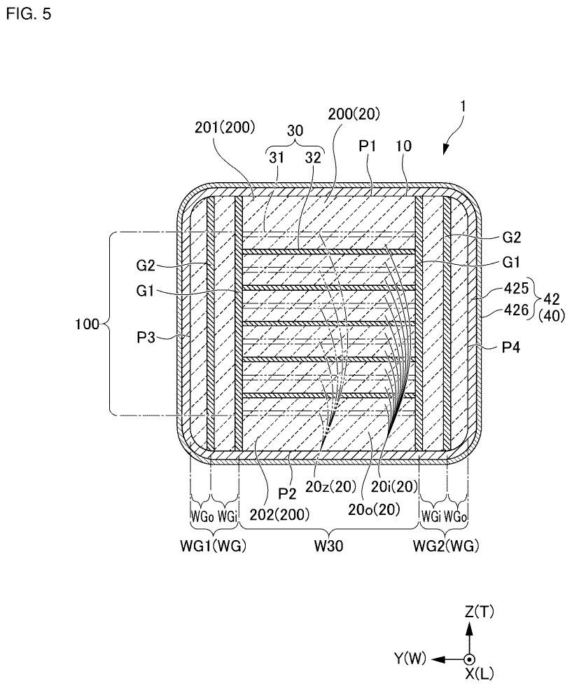

FIG. 1 is a perspective view of a multilayer ceramic capacitor. FIG. 2 is a cross-sectional view taken along line II-II of the multilayer ceramic capacitor illustrated in FIG. 1. FIG. 3 is a cross-sectional view taken along line III-III of the multilayer ceramic capacitor illustrated in FIG. 2. FIG. 4 is a cross-sectional view taken along line IV-IV of the multilayer ceramic capacitor illustrated in FIG. 3. FIG. 5 is a cross-sectional view taken along line V-V illustrated in FIG. 3. A multilayer ceramic capacitor 1 illustrated FIGS. 1 to 5 includes a multilayer body 10 and outer electrodes 40. The outer electrodes 40 include a first outer electrode 41 and a second outer electrode 42.

An XYZ orthogonal coordinate system is illustrated in FIGS. 1 to 5. The X direction is the length direction L of the multilayer ceramic capacitor 1 and the multilayer body 10, the Y direction is the width direction W of the multilayer ceramic capacitor 1 and the multilayer body 10, and the Z direction is the stacking direction T of the multilayer ceramic capacitor 1 and the multilayer body 10. Thus, the cross section illustrated in FIG. 2 is also called the LT cross section, the cross section illustrated in FIG. 3 is also called the LW cross section, and the cross section illustrated in FIGS. 4 and 5 is also called the WT cross section.

The length direction L, the width direction W, and stacking direction T need not be perpendicular to each other, and may intersect each other.

The multilayer body 10 has a substantially rectangular parallelepiped shape, and includes a first surface P1 and a second surface P2 facing each other in the stacking direction T, a third surface P3 and a fourth surface P4 facing each other in the width direction W, and a fifth surface P5 and a sixth surface P6 facing each other in the length direction L. Each of the surfaces may include protrusions and recesses, or may be roughened.

It is preferable that corner portions and ridge portions of the multilayer body 10 be rounded. A corner portion is a portion where three surfaces of the multilayer body 10 intersect, and a ridge portion is a portion where two surface of the multilayer body 10 intersect.

As illustrated in FIGS. 2 and 4, the multilayer body 10 includes a plurality of dielectric layer 20 and a plurality of inner electrode layers 30 that are stacked in the stacking direction T. The multilayer body 10 includes an inner layer portion 100, and a first outer layer portion 201 and a second outer layer portion 202 that are disposed in such way that the inner layer portion 100 is interposed therebetween in the stacking direction T.

The inner layer portion 100 includes a plurality of dielectric layers 20i and the plurality of inner electrode layers 30. The inner layer portion 100 is a region in which the dielectric layers 201 and the inner electrode layers 30 are alternately stacked and that is interposed between the inner electrode layers 30 that are located at both ends in the stacking direction T. The inner layer portion 100 is a portion in which the plurality of inner electrode layers 30 are disposed to face each other with the dielectric layers 20i therebetween and that practically functions as a capacitor by generating electrostatic capacitance.

The first outer layer portion 201 is disposed on the first surface P1 side of the multilayer body 10, and the second outer layer portion 202 is disposed on the second surface P2 side of the multilayer body 10. To be more specific, the first outer layer portion 201 is disposed between one of the plurality of inner electrode layers 30 that is nearest to the first surface P1 and the first surface P1, and the second outer layer portion 202 is disposed between one of the plurality of inner electrode layers 30 that is nearest to the second surface P2 and the second surface P2. The first outer layer portion 201 and the second outer layer portion 202 do not include the inner electrode layers 30.

As the material of the dielectric layers 20, it is possible to use, for example, dielectric ceramic including BaTiO₃, CaTiO₃, SrTiO₃, CaZrO₃, or the like as a main component. An Mn compound, an Fe compound, a Cr compound, a Co compound, an Ni compound, or the like may be added, as an accessory component, to the material of the dielectric layers 20.

The thickness of each dielectric layer 20, which is not particularly limited, is, for example, preferably greater than or equal to about 0.40 μm and less than or equal to about 0.50 μm and more preferably greater than or equal to about 0.40 μm and less than or equal to about 0.45 μm. The number of the dielectric layers 20, which is not particularly limited, is, for example, preferably greater than or equal to 100 and less than or equal to 2000. The number of the dielectric layers 20 is the sum of the number of the dielectric layers 20i in the inner layer portion 100 and the number of dielectric layers 20o in outer layer portions 200.

The plurality of inner electrode layers 30 include a plurality of first inner electrode layers 31 and a plurality of second inner electrode layers 32. The plurality of first inner electrode layers 31 and the plurality of second inner electrode layers 32 are alternately disposed in the stacking direction T of the multilayer body 10.

The first inner electrode layers 31 each include a first facing portion 311 and a first lead-out portion 312, and the second inner electrode layers 32 each include a second facing portion 321 and a second lead-out portion 322.

The first facing portion 311 and the second facing portion 321 face each other with the dielectric layer 20i therebetween in the stacking direction T of the multilayer body 10. The shape of the first facing portion 311 and the second facing portion 321, which is not particularly limited, may be, for example, a substantially rectangular shape. The first facing portion 311 and the second facing portion 321 are portions that generate electrostatic capacitance and practically function as a capacitor.

The first lead-out portion 312 extends from the first facing portion 311 toward the fifth surface P5 of the multilayer body 10 and is exposed on the fifth surface P5. The second lead-out portion 322 extends from the second facing portion 321 toward the sixth surface P6 of the multilayer body 10 and is exposed on the sixth surface P6. The lengths of the first facing portion 311 and the first lead-out portion 312 in the width direction W may be the same or may be different. The lengths of these portions in the width direction W may gradually change toward the exposed fifth surface P5. The lengths of the second facing portion 321 and the second lead-out portion 322 in the width direction W may be the same or may be different. The lengths of these portions in the width direction W may gradually change toward the exposed sixth surface P6.

Thus, the first inner electrode layers 31 are connected to the first outer electrode 41, and a distance is provided between the first inner electrode layers 31 and the sixth surface P6 of the multilayer body 10, that is, the second outer electrode 42. The second inner electrode layers 32 are connected to the second outer electrode 42, and a distance is provided between the second inner electrode layers 32 and the fifth surface P5 of the multilayer body 10, that is, the first outer electrode 41.

The first inner electrode layers 31 and the second inner electrode layers 32 include metal Ni as a main component. The first inner electrode layers 31 and the second inner electrode layers 32 may include, as a main component or as a component other than a main component, for example, at least one selected from metals such as Cu, Ag, Pd, and Au and alloys including at least one of these metals, such as Ag—Pd alloy. The first inner electrode layers 31 and the second inner electrode layers 32 may further include, as a component other than a main component, dielectric particles having the same composition as ceramic included in the dielectric layers 201. In the present specification, a main component metal is defined as a metal component having the highest weight %.

The thickness of each of the first inner electrode layers 31 and the second inner electrode layers 32, which is not particularly limited, is, for example, preferably greater than or equal to about 0.30 μm and less than or equal to about 0.40 μm and more preferably greater than or equal to about 0.30 μm and less than or equal to about 0.35 μm. The number of the first inner electrode layers 31 and the second inner electrode layers 32, which is not particularly limited, is, for example, preferably greater than or equal to 10 and less than or equal to 1000.

Examples of a method of measuring the thickness of each of the dielectric layers 20i and the inner electrode layers 30 include a method of observing the LT cross section in the vicinity of the center in the width direction of the multilayer body, which is exposed by polishing, by using a scanning electron microscope. Each value may be the average of measurements at a plurality of positions in the length direction or may be the average of measurements at a plurality of positions in the stacking direction.

As illustrated in FIG. 4, the multilayer body 10 includes, in the width direction W, an electrode facing portion W30 in which the inner electrode layers 30 face each other, and a first side-margin portion WG1 and a second side-margin portion WG2 that are disposed in such a way that the electrode facing portion W30 is interposed therebetween. The first side-margin portion WG1 is located between the electrode facing portion W30 and the third surface P3, and the second side-margin portion WG2 is located between the electrode facing portion W30 and the fourth surface P4. To be more specific, the first side-margin portion WG1 is located between ends of the inner electrode layers 30 on the third surface P3 side and the third surface P3, and the second side-margin portion WG2 is located between ends of the inner electrode layers 30 on the fourth surface P4 side and the fourth surface P4. The first side-margin portion WG1 and the second side-margin portion WG2 do not include the inner electrode layers 30 and include only the dielectric layers 20. The first side-margin portion WG1 and the second side-margin portion WG2 are also referred to as W gaps.

The first side-margin portion WG1 and the second side-margin portion WG2 may include segregation of Si. Thus, it is possible to improve the flexural strength of the multilayer ceramic capacitor.

As illustrated in FIG. 2, the multilayer body 10 includes, in the length direction L, an electrode facing portion L30 in which the first inner electrode layers 31 and the second inner electrode layers 32 of the inner electrode layers 30 face each other, a first end-margin portion LG1, and a second end-margin portion LG2. The first end-margin portion LG1 is located between the electrode facing portion L30 and the fifth surface P5, and the second end-margin portion LG2 is located between the electrode facing portion L30 and the sixth surface P6. To be more specific, the first end-margin portion LG1 is located between ends of the second inner electrode layers 32 on the fifth surface P5 side and the fifth surface P5, and the second end-margin portion LG2 is located between ends of the first inner electrode layers 31 on the sixth surface P6 side and the sixth surface P6.

The first end-margin portion LG1 includes the first inner electrode layers 31 and the dielectric layers 20 and does not include the second inner electrode layers 32. Therefore, steps at the ends of the second inner electrode layers 32 on the fifth surface P5 side are eliminated by disposing dielectric layers 20z each having a thickness corresponding to the thickness of each of the second inner electrode layers 32. The second end-margin portion LG2 includes the second inner electrode layers 32 and the dielectric layers 20 and does not include the first inner electrode layers 31. Therefore, steps at the ends of the first inner electrode layers 31 on the sixth surface P6 side are eliminated by disposing dielectric layers 20z each having a thickness corresponding to the thickness of each of the first inner electrode layers 31.

It is not necessary to dispose the dielectric layers 20z, and the multilayer body 10 may be formed without disposing the dielectric layers 20z.

The first end-margin portion LG1 is a portion that functions as a lead-out electrode portion of the first inner electrode layers 31 to the fifth surface P5, and the second end-margin portion LG2 is a portion that functions as a lead-out electrode portion of the second inner electrode layers 32 to the sixth surface P6. The first end-margin portion LG1 and the second end-margin portion LG2 are also referred to as L gaps.

The first facing portions 311 of the first inner electrode layers 31 and the second facing portions 321 of the second inner electrode layers 32 described above are located in the electrode facing portion L30. The first lead-out portions 312 of the first inner electrode layers 31 described above are located in the first end-margin portion LG1, and the second lead-out portions 322 of the second inner electrode layers 32 described above are located in the second end-margin portion LG2.

Examples of a method of measuring the thickness of each portion of the multilayer body 10 include a method of observing the LT cross section in the vicinity of the center in the width direction of the multilayer body, which is exposed by polishing, or the WT cross section in the vicinity of the center in the length direction of the multilayer body, which is exposed by polishing, by using a scanning electron microscope. Each value may be the average of measurements at a plurality of positions in the length direction or the width direction.

Likewise, examples of a method of measuring the length of each portion of the multilayer body 10 include a method of observing the LT cross section in the vicinity of the center in the width direction of the multilayer body, which is exposed by polishing, by using a scanning electron microscope. Each value may be the average of measurements at a plurality of positions in the stacking direction.

Likewise, examples of a method of measuring the width of each portion of the multilayer body 10 include a method of observing the WT cross section in the vicinity of the center in the length direction of the multilayer body, which is exposed by polishing, by using a scanning electron microscope. Each value may be the average of measurements at a plurality of positions in the stacking direction.

The outer electrodes 40 include the first outer electrode 41 and the second outer electrode 42.

The first outer electrode 41 is disposed on the fifth surface P5 of the multilayer body 10 and connected to the first inner electrode layers 31. The first outer electrode 41 may extend from the fifth surface P5 to a portion of the first surface P1 and a portion of the second surface P2. The first outer electrode 41 may extend from the fifth surface P5 to a portion of the third surface P3 and a portion of the fourth surface P4.

The second outer electrode 42 is disposed on the sixth surface P6 of the multilayer body 10 and connected to the second inner electrode layers 32. The second outer electrode 42 may extend from the sixth surface P6 to a portion of the first surface P1 and a portion of the second surface P2. The second outer electrode 42 may extend from the sixth surface P6 to a portion of the third surface P3 and a portion of the fourth surface P4.

The first outer electrode 41 includes a first underlying electrode layer 415 and a first plating layer 416, and the second outer electrode 42 includes a second underlying electrode layer 425 and a second plating layer 426. However, the first outer electrode 41 may include only the first plating layer 416, and the second outer electrode 42 may include only the second plating layer 426.

The first underlying electrode layer 415 and the second underlying electrode layer 425 each may be a fired layer including metal and glass. Examples of the glass include a glass component including at least one selected from B, Si, Ba, Mg, Al, Li, and the like. A specific example is borosilicate glass. The metal includes Cu as a main component. The metal may include, as a main component or as a component other than a metal component, for example, at least one selected from metals such as Ni, Ag, Pd, and Au, and alloys such as Ag—Pd alloy.

The fired layer is a layer that is formed by applying, to the multilayer body, an electrically conductive paste including metal and glass by using a dipping method and firing the electrically conductive paste. Firing may be performed after firing of the inner electrode layers or may be fired simultaneously with firing of the inner electrode layers. The fired layer may include a plurality of layers.

Alternatively, the first underlying electrode layer 415 and the second underlying electrode layer 425 each may be a resin layer including electroconductive particles and a thermosetting resin. The resin layer may be formed on the fired layer described above or may be formed directly on the multilayer body without forming the fired layer.

The resin layer is a layer that is formed by applying an electrically conductive paste including electroconductive particles and a thermosetting resin to the multilayer body and firing the electrically conductive paste. Firing may be performed after firing of the inner electrode layers or may be fired simultaneously with firing of the inner electrode layers. The resin layer may include a plurality of layers.

The thickness of each of the first underlying electrode layer 415 and the second underlying electrode layer 425, as fired layers or resin layers, per layer is not particularly limited, and may be greater than or equal to about 1 μm and less than or equal to about 10 μm, for example.

Alternatively, the first underlying electrode layer 415 and the second underlying electrode layer 425 each may be a thin film layer that is formed by depositing metal particles by using a thin film forming method such as sputtering or vapor deposition and thickness of that is less than or equal to about 1 μm, for example.

The first plating layer 416 covers at least a portion of the first underlying electrode layer 415, and the second plating layer 426 covers at least a portion of the second underlying electrode layer 425. The first plating layer 416 and the second plating layer 426 each include, for example, at least one selected from metals such as Cu, Ni, Ag, Pd, and Au, and alloys such as Ag—Pd alloy.

The first plating layer 416 and the second plating layer 426 each may include a plurality of layers. A two-layer structure of an Ni plating and an Sn plating is preferable. The Ni plating layer can prevent corrosion of the underlying electrode layer by solder when a ceramic electronic component is being mounted, and the Sn-plating layer can improve wettability of solder when a ceramic electronic component is being mounted and facilitates mounting of the ceramic electronic component. The first plating layer 416 and the second plating layer 426 each may have a three-layer structure that is formed by, for example, stacking an Sn plating layer, an Ni plating, and an Sn plating. An outermost layer may be Au plating.

The thickness of each of the first plating layer 416 and the second plating layer 426 per layer, which is not particularly limited, may be greater than or equal to about 1 μm and less than or equal to about 10 μm, for example.

A first glass layer G1 is disposed on each of two sides of the inner layer portion 100 in the width direction W in such a way as to extend in the stacking direction T along an end surface LS of the multilayer body 10.

By disposing the first glass layer G1 on each of two sides of the inner layer portion 100 in the width direction W along the end surface LS of the multilayer body 10, it is possible to prevent ingress of water through a gap between the multilayer body 10 and the outer electrode 40 and achieve high moisture resistance.

In the example embodiment illustrated in FIG. 3, an example in which the first glass layer G1 is disposed along each of the fifth surface P5 and the sixth surface P6 is illustrated. However, this is not a limitation, and the first glass layer G1 may be disposed along either the fifth surface P5 or the sixth surface P6 of the multilayer body 10.

As illustrated in FIG. 5, the first glass layer G1 extends from the first surface P1 to the second surface P2. However, it is not necessary that the first glass layer G1 be disposed continuously from the first surface P1 to the second surface P2. As long as the first glass layer G1 is disposed on each of two sides of the inner layer portion 100 in the width direction W in such a way as to extend in the stacking direction T, it is possible to prevent water that has entered through a gap between the multilayer body 10 and the outer electrode 40 from reaching the inner electrode layers 30.

A second glass layer G2 is disposed in the inside of the side-margin portion WG on each of two sides of the inner layer portion 100 in the width direction W in such a way as to extend in the stacking direction T along the end surface LS of the multilayer body 10.

By disposing the second glass layer G2 in the inside of the side-margin portion WG along the end surface IS of the multilayer body 10, it is possible to prevent ingress of water through a gap between the multilayer body 10 and the outer electrode 40 and to achieve high moisture resistance.

Each of the side-margin portions WG may include an inside layer WGi and an outside layer WGo stacked in the width direction W, and the second glass layer G2 may be disposed between the inside layer WGi and the outside layer WGo. For example, it is possible to dispose the second glass layer G2 in the inside of the side-margin portion WG by applying a second glass paste GP2 for forming the second glass layer G2 to either the inside layer WGi or the outside layer WGo and by stacking the inside layer WGi and the outside layer WGo with the second glass paste GP2 therebetween and firing the second glass paste GP2.

In the example embodiment illustrated in FIG. 3, an example in which the second glass layer G2 is disposed along each of the fifth surface P5 and the sixth surface P6 of the multilayer body 10 is illustrated. However, this is not a limitation, and the second glass layer G2 may be disposed along either the fifth surface P5 or the sixth surface P6.

As illustrated in FIG. 5, the second glass layer G2 extends from the first surface P1 to the second surface P2. However, it is not necessary that the second glass layer G2 be disposed continuously from the first surface P1 to the second surface P2. As long as the second glass layer G2 is disposed on each of two sides of the inner layer portion 100 in the width direction W in the inside of the side-margin portion WG in such a way as to extend in the stacking direction T, it is possible to prevent water that has entered through a gap between the multilayer body 10 and the outer electrode 40 from reaching the inner electrode layers 30.

In the present example embodiment, an example of the multilayer ceramic capacitor 1 in which the first glass layer G1 and the second glass layer G2 are disposed is described. However, it is possible to improve moisture resistance by disposing either the first glass layer G1 or the second glass layer G2.

The length in the length direction L of the first glass layer G1 disposed along the fifth surface P5 or the length in the length direction L of the second glass layer G2 disposed along the fifth surface P5 may be substantially the same as or shorter than the length in the length direction L of the first lead-out portions 312 of the first inner electrode layers 31. The length in the length direction L of the first glass layer G1 disposed along the sixth surface P6 or the length in the length direction L of the second glass layer G2 disposed along the sixth surface P6 may be substantially the same as or shorter than the length in the length direction L of the second lead-out portions 322 the second inner electrode layers 32. It t is possible to sufficiently obtain an effect of improvement of moisture resistance by disposing either the first glass layer G1 or the second glass layer G2 having such a length.

In the present example embodiment, an example in which the lengths in the length direction L of the first glass layer G1 and the second glass layer G2 are the same length is described. However, the lengths in the length direction L of the first glass layer G1 and the second glass layer G2 may be different, and, for example, the length in the length direction L of the first glass layer G1 may be shorter than the length in the length direction L of the second glass layer G2.

Next, an example of a method of manufacturing the multilayer ceramic capacitor 1 will be described. First, a dielectric sheet for the dielectric layers 20 and an electrically conductive paste for the inner electrode layers 30 are prepared. A binder and a solvent are included in the dielectric sheet and the electrically conductive paste. As the binder and the solvent, known materials can be used.

Next, an inner electrode pattern is formed on the dielectric sheet by printing the electrically conductive paste on the dielectric sheet, for example, in a predetermined pattern. As a method of forming the inner electrode pattern, it is possible to use screen printing, gravure printing, or the like.

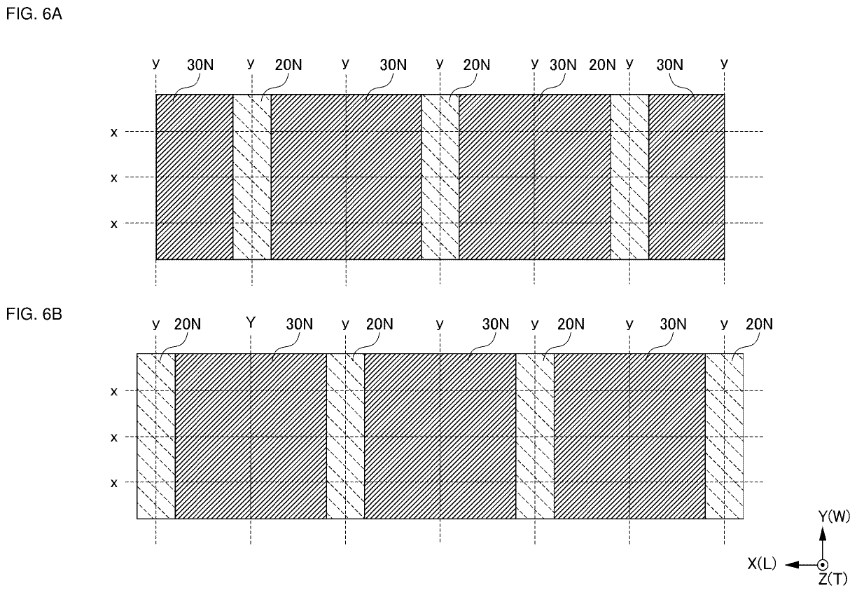

In mass production, it is possible to prepare a dielectric sheet having two inner electrode patterns illustrated in FIGS. 6A and 6B. Application portions 30N, to which the electrically conductive paste is applied, are arranged at distances therebetween in the length direction L, and a height adjustment portion 20N is formed between adjacent application portions 30N by applying a ceramic paste. The height adjustment portion 20N is applied with a thickness that is approximately the same as the thickness of the electrically conductive paste on the application portions 30N. Thus, a step on the dielectric sheet, which is formed due to application of the electrically conductive paste, is eliminated, and the surface of the dielectric sheet to which the electrically conductive paste is applied is smoothed. As illustrated in FIGS. 6A and 6B, two inner electrode layer patterns are printed in such a way as to be displaced in the length direction L. As described below, it is possible to form the structure of the inner layer portion 100 of the multilayer body 10 by alternately stacking dielectric sheets having the two inner electrode patterns and cutting the dielectric sheets in the stacking direction T along a cutting line x and a cutting line y. In the multilayer body 10 after being fired, the application portions 30N, to which the electrically conductive paste is applied, form the first inner electrode layers 31 and the second inner electrode layers 32 in the inner layer portion 100, the height adjustment portions 20N form the dielectric layers 20z in the inner layer portion 100, and the dielectric sheets form the dielectric layers 20i of the inner layer portion 100.

In order to form the outer layer portion 200, a predetermined number of dielectric sheets for the second outer layer portion 202, on which inner electrode patterns are not printed, are stacked. On the dielectric sheets, dielectric sheets for the inner layer portion 100, on which two inner electrode patterns are printed, are alternately stacked. On the dielectric sheets, a predetermined number of dielectric sheets for the first outer layer portion 201, on which inner electrode patterns are not printed, are stacked. Thus, a stacked sheet is produced.

Next, the stacked sheet is pressed in the stacking direction by isostatic pressing or the like to produce a stacked block. Next, the stacked block is cut in the stacking direction T along the cutting line x and the cutting line y illustrated in FIGS. 6A and 6B into predetermined sizes to produce multilayer body chips 10T.

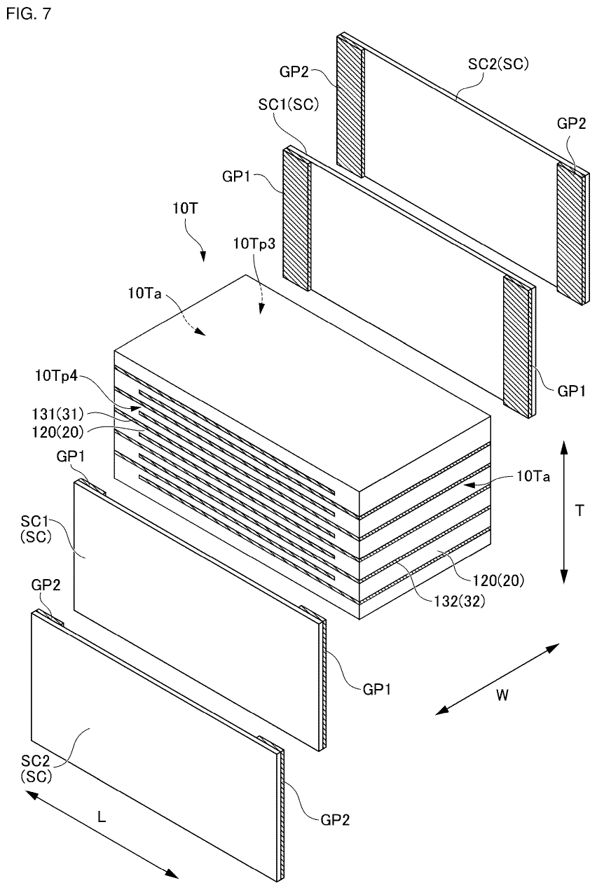

As illustrated in FIG. 7, each multilayer body chip 10T has a substantially rectangular parallelepipedo shape such that a plurality of material sheets, on each of which a conductor pattern 131 to become the first inner electrode layer 31 is printed, and a plurality of material sheets, on each of which a conductor pattern 132 to become the second inner electrode layer 32 is printed, are alternately stacked on the surfaces of ceramic green sheets 120 to become the dielectric layers 20.

The conductor pattern 131 is exposed on one of a pair of end surfaces 10Ta of the multilayer body chip 10T, and the conductor pattern 132 is exposed on the other end surface.

At a third surface 10Tp3 of the multilayer body chip 10T, all end portions in the width direction W of the conductor patterns 131 and the conductor patterns 132, which are disposed to be stacked, are arranged along the stacking direction T on the third surface 10Tp3 that is cut out and exposed.

Thus, on the third surface P3 side of the multilayer ceramic capacitor 1, end portions in the width direction W of the plurality of inner electrode layers 30 can be disposed in such a way as to be arranged within the range of about 5 μm in the width direction W, for example.

Likewise, at a fourth surface 10Tp4 of the multilayer body chip 10T, all end portions in the width direction W of the conductor patterns 131 and the conductor patterns 132, which are disposed to be stacked, are arranged along the stacking direction T on the fourth surface 10Tp4 that is cut out and exposed.

Thus, on the fourth surface P4 side of the multilayer ceramic capacitor 1, end portions in the width direction W of the plurality of inner electrode layers 30 can be disposed in such a way as to be arranged within the range of about 5 μm in the width direction W, for example.

Side covering portions SC for forming the first side-margin portions WG1 and the second side-margin portions WG2 are attached to the third surface 10Tp3 and the fourth surface 10Tp4 of the multilayer body chip 10T in such a way as to respectively cover these. It is possible to use ceramic green sheets as the side covering portions sc.

The side covering portions SC may each include a third-surface covering portion SC1 and a fourth-surface covering portion SC2. To a surface of the third-surface covering portion SC1 on the multilayer body chip 10T side, a first glass paste GP1 is applied in the stacking direction T along the end surface LS of the multilayer body 10 after being fired. To a surface of the fourth-surface covering portion SC2 on the multilayer body chip 10T side, the second glass paste GP2 is applied in the stacking direction T along the end surface LS of the multilayer body 10 after being fired.

It is possible to apply the first glass paste GP1 to the third-surface covering portion SC1 and to apply the second glass paste GP2 to the fourth-surface covering portion SC2 by, for example, screen printing, gravure printing, or the like. It is possible to control the thickness of the first glass paste and the second glass paste by changing the thickness of a printing plate. It is possible to control the hardness of the first glass layer G1 and the second glass layer G2 after being fired by changing the glass composition ratio.

By disposing the third-surface covering portion SC1, to which the first glass paste GP1 is applied, and the fourth-surface covering portion SC2, to which the second glass paste GP2 is applied, on each of the third surface 10Tp3 and the fourth surface 10Tp4 of the multilayer body chip 10T, the multilayer body 10 after being fired has a structure such that the first glass layer G1 is disposed on each of two sides in the width direction W of the inner layer portion 100 in such a way as to extend in the stacking direction T along the end surface LS of the multilayer body 10 and the second glass layer G2 is disposed in the inside of the side-margin portion WG in such a way as to extend in the stacking direction T along the end surface LS of the multilayer body 10.

In the example embodiment illustrated in FIG. 7, a step of applying the first glass paste GP1 to the third-surface covering portion SC1 and affixing the third-surface covering portion SC1, to which the first glass paste is applied, to a side surface of the multilayer body chip 10T is described. However, this is not a limitation, and, for example, a step of applying the first glass paste GP1 to a side surface of the multilayer body chip 10T and affixing the third-surface covering portion SC1 onto the applied first glass paste GP1 may be performed.

In the example embodiment illustrated in FIG. 7, a step of applying the second glass paste GP2 to the fourth-surface covering portion SC2 and affixing the fourth-surface covering portion SC2, to which the second glass paste GP2 is applied, to the third-surface covering portion SC1 is described. However, this is not a limitation, and, for example, a step of applying the second glass paste GP2 to the third-surface covering portion SC1 and affixing the fourth-surface covering portion SC2 onto the applied second glass paste GP2 may be performed.

In the example embodiment illustrated in FIG. 7, an example in which the first glass paste GP1 is applied to the multilayer body 10 after being fired along each of the fifth surface P5 and the sixth surface P6 is described. However, this is not a limitation, and the first glass paste GP1 can be applied along either the fifth surface P5 or the sixth surface P6. Likewise, in the example embodiment illustrated in FIG. 7, an example in which the second glass paste GP2 is applied to the multilayer body 10 after being fired along each of the fifth surface P5 and the sixth surface P6 is described. However, this is not a limitation, and the second glass paste GP2 can be applied along either the fifth surface P5 or the sixth surface P6.

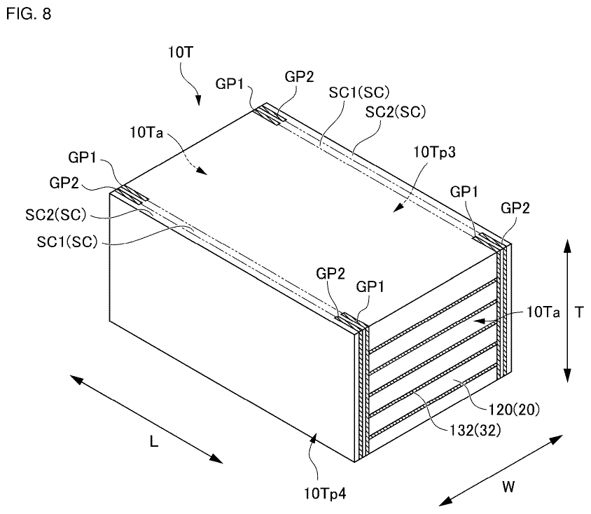

Through the above process, as illustrated in FIG. 8, the multilayer body chip 10T that has not been fired and includes the side covering portions SC to which a glass paste is applied is formed.

Next, the multilayer body 10 is produced by firing the multilayer body chip 10T. It is preferable that the firing temperature, which may depend on the materials of dielectric and inner electrodes, be higher than or equal to about 900 °C and lower than or equal to about 1400 °C, for example.

Next, by using a dipping method, an electrically conductive paste for the first underlying electrode layer 415 is applied to the fifth surface P5 by immersing the fifth surface P5 of the multilayer body 10 in the electrically conductive paste, which is an electrode material for the underlying electrode layer. Likewise, by using a dipping method, an electrically conductive paste for the second underlying electrode layer 425 is applied to the sixth surface P6 by immersing the sixth surface P6 of the multilayer body 10 in the electrically conductive paste, which is an electrode material for the underlying electrode layer. Subsequently, by firing these electrically conductive pastes, the first underlying electrode layer 415 and the second underlying electrode layer 425, which are fired layers, are formed. It is preferable that the firing temperature be higher than or equal to about 600 °C and lower than or equal to about 900 °C, for example.

As described above, the first underlying electrode layer 415 and the second underlying electrode layer 425 may be formed as resin layers by applying an electrically conductive paste including electroconductive particles and a thermosetting resin by using an application method and firing the electrically conductive paste, or the first underlying electrode layer 415 and the second underlying electrode layer 425 may be formed as thin layers by using a thin-film forming method such as sputtering or vapor deposition.

Subsequently, the first outer electrode 41 is formed by forming the first plating layer 416 on a surface of the first underlying electrode layer 415, and the second outer electrode 42 is formed by forming the second plating layer 426 on a surface of the second underlying electrode layer 425. Through the above process, the multilayer ceramic capacitor 1 described above is obtained.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including:
a first surface and a second surface facing each other in a stacking direction, a third surface and a fourth surface facing each other in a width direction intersecting the stacking direction, and a fifth surface and a sixth surface facing each other in a length direction intersecting the stacking direction and the width direction;
a first outer electrode on the fifth surface of the multilayer body; and
a second outer electrode on the sixth surface of the multilayer body; wherein
the multilayer body includes:
an inner layer portion in which an inner electrode layer and a dielectric layer are stacked; and
a side-margin portion on each of two sides of the inner layer portion in a width direction; and
in the multilayer body, a first glass layer is located on at least one of the two sides of the inner layer portion in the width direction along the fifth surface.

2. The multilayer ceramic capacitor according to claim 1, wherein, in the multilayer body, the first glass layer is located on each of the two sides of the inner layer portion in the width direction along the fifth surface.

3. The multilayer ceramic capacitor according to claim 1, wherein the first glass layer is exposed on the fifth surface.

4. The multilayer ceramic capacitor according to claim 1, wherein the first glass layer extends in the stacking direction.

5. The multilayer ceramic capacitor according to claim 1, wherein the first glass layer extends from the first surface to the second surface.

6. The multilayer ceramic capacitor according to claim 1, wherein a second glass layer is located inside of the side-margin portion.

7. The multilayer ceramic capacitor according to claim 1, wherein a second glass layer is located inside of the side-margin portion.

8. The multilayer ceramic capacitor according to claim 6, wherein the second glass layer extends in the stacking direction.

9. The multilayer ceramic capacitor according to claim 6, wherein the second glass layer extends from the first surface to the second surface.

10. A multilayer ceramic capacitor comprising:
a multilayer body including:
a first surface and a second surface facing each other in a stacking direction, a third surface and a fourth surface facing each other in a width direction intersecting the stacking direction, and a fifth surface and a sixth surface facing each other in a length direction intersecting the stacking direction and the width direction;
a first outer electrode on the fifth surface of the multilayer body; and
a second outer electrode on the sixth surface of the multilayer body; wherein
the multilayer body includes:
a first internal electrode exposed on the fifth surface;
a second internal electrode exposed on the sixth surface; and
a first glass layer is located on a side of the second internal electrode in cross section view along the stacking direction and the width direction without the first internal electrode.

11. The multilayer ceramic capacitor according to claim 10, wherein the first glass layer extends in the stacking direction.

12. The multilayer ceramic capacitor according to claim 10, wherein the first glass layer extends from the first surface to the second surface.

13. The multilayer ceramic capacitor according to claim 10, wherein the first glass layer is located on both sides of the second internal electrode in cross section view along the stacking direction and the width direction without the first internal electrode.

14. The multilayer ceramic capacitor according to claim 13, wherein the first glass layer extends in the stacking direction.

15. The multilayer ceramic capacitor according to claim 13, wherein the first glass layer extends from the first surface to the second surface.

16. The multilayer ceramic capacitor according to claim 10, further comprising:
a side-margin portion on two sides of the second internal electrode in the width direction; and
a second glass layer located inside of the side-margin portion.

17. The multilayer ceramic capacitor according to claim 10, further comprising:
a side-margin portion on two sides of the second internal electrode in the width direction; and
a second glass layer extending in the stacking direction.

18. The multilayer ceramic capacitor according to claim 10, further comprising:
a side-margin portion on two sides of the second internal electrode in the width direction; and
a second glass layer extending from the first surface to the second surface.
